(19) United States
(12) Patent Application Publication
(10) Pub. No.: US 2026/0205883 A1
(43) Pub. Date: Jul. 16, 2026

(54) USER EQUIPMENT, BASE STATION, COMMUNICATION NETWORK NODE, AND METHOD

(71) Applicant: Sony Group Corporation, Tokyo (JP)

(72) Inventors: Hideji WAKABAYASHI, Basingstoke (GB); Yuxin WEI, Basingstoke (GB); Yassin Aden AWAD, Basingstoke (GB); Vivek SHARMA, Basingstoke (GB)

(73) Assignee: Sony Group Corporation, Tokyo (JP)

(21) Appl. No.: 19/135,821

(22) PCT Filed: Dec. 20, 2023
(86) PCT No.: PCT/EP2023/087049

§ 371 Date: Jun. 5, 2025

(30) Foreign Application Priority Data
Dec. 23, 2022 (EP) 22216649.8

(51) Int. Cl. H04W 28/10; H04W 8/24; H04W 72/11

(52) U.S. Cl. CPC H04W 28/10; H04W 8/24; H04W 72/11

(57) ABSTRACT

The present disclosure pertains to a user equipment for a mobile telecommunications network, the user equipment including circuitry configured to: transmit, to a base station, a signal of operation status indication, wherein the signal of operation status indication is transmitted with a predetermined time interval from a previous transmission of an operation status indication.

### TECHNICAL FIELD

The present disclosure generally pertains to a user equipment, a base station, a communication network node, and a method for operating a 5G network in an industrial environment.

### TECHNICAL BACKGROUND

In 3GPP IoT (Internet of Things) Rel-16 and Rel-17, functions for industrial internet of things (IIoT) are introduced. These releases were made for supporting industry 4.0, factory automation, smart cities, and the like.

One feature of these releases is time sensitive communication (TSC), which may enable to handle a highly accurate time synchronization between devices, low latency traffic and highly reliable communication.

According to 3GPP, TSC should be compatible with the wired based time sensitive network (TSN). However, IIoT covers a wide variety of applications and the requirements are quite different from the conventional 3GPP applications such as voice, text, web browsing, and so on. Although there exist techniques for providing industrial internet of things, it is generally desirable to provide a user equipment, a base station, a communication network node, and a method.

### SUMMARY

According to a first aspect, the disclosure provides a user equipment for a mobile telecommunications network, the user equipment comprising circuitry configured to:
transmit, to a base station, a signal of operation status indication, wherein the signal of operation status indication is transmitted within a predetermined time interval from a previous transmission of an operation status indication.

According to a second aspect, the disclosure provides a user equipment for a mobile telecommunications network, the user equipment comprising circuitry configured to:
receive, from a base station, with allocated resources an emergency indication; and
carry out an emergency action in response to receiving the emergency indication.

According to a third aspect, the disclosure provides a base station for a mobile telecommunications network, the base station comprising circuitry configured to:
receive, from the user equipment, a signal of operation status indication, wherein the signal of operation status indication is transmitted within a predetermined time interval from a previous transmission of an operation status indication.

According to a fourth aspect, the disclosure provides a base station for a mobile telecommunications network, the base station comprising circuitry configured to:
send, to a user equipment, with allocated resources an emergency indication.

According to a fifth aspect, the disclosure provides a method carried out in a user equipment for a mobile telecommunications network, the method comprising:
transmitting, to a base station, a signal of operation status indication, wherein the signal of operation status indication is transmitted within a predetermined time interval from a previous transmission of an operation status indication.

According to a sixth aspect, the disclosure provides a method carried out in a user equipment for a mobile telecommunications network, the method comprising:
receiving, from a base station, with allocated resources an emergency indication; and
carrying out an emergency action in response to receiving the emergency indication.

According to a seventh aspect, the disclosure provides a method carried out in a base station for a mobile telecommunications network, method comprising:
receiving, from a user equipment, a signal of operation status indication, wherein the signal of operation status indication is transmitted within a predetermined time interval from a previous transmission of an operation status indication.

According to a eighth aspect, the disclosure provides a method carried out in a base station for a mobile telecommunications network, the method comprising:
sending, to a user equipment, with allocated resources an emergency indication.

According to a ninth aspect, the disclosure provides a user equipment for a mobile telecommunications network, the user equipment comprising circuitry configured to:
obtain surveillance data;
input the surveillance data into a machine vision algorithm;
determine a level of risk attributed to the surveillance data based on the machine vision algorithm; and
send an emergency command, if the level of risk exceeds a predetermined threshold.

According to a tenth aspect, the disclosure provides a communication network node for a mobile telecommunications network, the user equipment comprising circuitry configured to:
receive an emergency command from the user equipment.

According to an eleventh aspect, the disclosure provides a method carried out in a user equipment for a mobile telecommunications network, the method comprising:
obtaining surveillance data;
inputting the surveillance data into a machine vision algorithm;
determining a level of risk attributed to the surveillance data based on the machine vision algorithm; and
sending an emergency command, if the level of risk exceeds a predetermined threshold

According to a twelfth aspect, the disclosure provides a method carried out in a communication network node for a mobile telecommunications network, the method comprising:
receiving an emergency command from the user equipment.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 depicts a schematic diagram for uplink communication;

FIG. 2 depicts a method according to the present disclosure which is carried out on a transmitter side;

FIG. 3 depicts a method according to the present disclosure which is carried out on a receiver side;

FIG. 4 depicts an embodiments showing SLS;

FIG. 5 depicts a velocity diagram a robot's operation speed;

FIG. 6 depicts a block diagram of a mobile telecommunications network according to the present disclosure for providing machine vision and an SLS function;

FIG. 7 depicts different QoS flows according to the present disclosure;

FIG. 8 depicts a block diagram of a method which is carried out on a machine vision side; and

FIG. 9 depicts a block diagram of a method which is carried out on a SLS side.

### DETAILED DESCRIPTION OF EMBODIMENTS

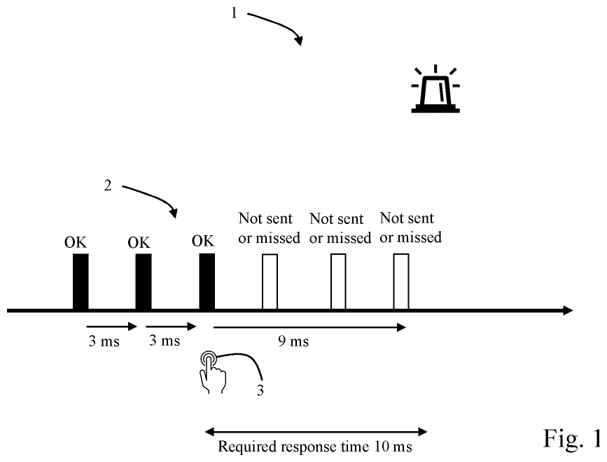

Before a detailed description of the embodiments under starting with FIG. 1 is given, general explanations are made.

In the present disclosure, the following definitions are used:
Configured Grant (CG): See patent application publication WO 2022/029112 A1: Configured Grant UCI Multiplexing on PUSCH Repetitions
Semi-persistence scheduling (SPS): See patent application publication WO 2022/152433 A1: HARQ-ACK bundling for different SPS instances in an SPS Group
Time sensitive network (TSN): See WO 2021/209235 A1 Grand Master Clock UE (DS-TT) providing uplink synchronizations for TSN
Application function (AF): An application function is an interface between TSN CNC and 5G (see below)

The following definitions are in accordance with Cisco's IoT white paper, as retrieved from [1]:
TSN Solution Components: There may be five main components in TSN (time-sensitive network):
TSN flow: Term used to describe time-critical communication between end devices. Each flow has strict time requirements that the networking devices honor. Each TSN flow is uniquely identified by the network devices.
End device: Source and destination of TSN flow. The end device may run an application that may requires deterministic communication. End devices are also referred to as talkers and listeners.
Bridges: Also referred to as Ethernet switches. For TSN, these are special bridges capable of transmitting the Ethernet frames of a TSN flow on a schedule and receiving Ethernet frames of a TSN flow according to a schedule.
Central network controller (CNC): For TSN, the CNC acts as a proxy for the Network (the TSN Bridges and their interconnections) and the control applications that require deterministic communication. The CNC defines the schedule on which all TSN frames are transmitted. The CNC application is provided by the vendor of the TSN bridges.
Centralized user configuration (CUC): An application that communicates with the CNC and the end devices. The CUC represents the control applications and the end devices. The CUC makes requests to the CNC for deterministic communication (TSN flows) with specific requirements for those flows. The CUC is an application that is vendor specific. Typically, the vendor of the TSN end devices will supply a CUC for those end devices.

The following definition of TSC (time-sensitive communication) assistance information TSCAI) is in accordance with 3GPP IoT Release 17.

The TSCAI may include the following parameters:
Flow direction: Direction of TSC flow (uplink or downlink)
Periodicity: Time-period between start of two bursts
Burst arrival time: Latest possible time when first packet of data burst arrives at either the ingress of RAN (radio access network) (downlink flow direction) or egress interface of a user equipment (UE) (uplink flow direction)
Survival time: As defined in 3GPP TS 22.261 (Service requirements for 5G systems); refers to a time period an application can survive without any bursts

The following definition pertains to Fieldbus:
Fieldbus is the name of a family of industrial computer networks used for real-time distributed control. Fieldbus profiles are standardized by the International Electrotechnical Commission (IEC) as IEC 61784/61158.

A complex automated industrial system is typically structured in hierarchical levels as a distributed control system (DCS). In this hierarchy the upper levels for production managements are linked to the direct control level of programmable logic controllers (PLC) via a non-time-critical communications system (e.g. Ethernet). The fieldbus links the PLCs of the direct control level to the components in the plant of the field level such as sensors, actuators, electric motors, console lights, switches, valves and contactors and replaces the direct connections via current loops or digital I/O signals. The requirement for a fieldbus are therefore time-critical and cost sensitive. Since the new millennium a number of fieldbuses based on Real-time Ethernet have been established. These have the potential to replace traditional fieldbuses in the long term.

The following definition is obtained from 3GPP TS 23.501 V17.5.0 (2022-06):

The 5G System architecture includes the following network functions (NF):
Authentication Server Function (AUSF).
Access and Mobility Management Function (AMF).
Data Network (DN), e.g. operator services, Internet access or 3rd party services.
Unstructured Data Storage Function (UDSF).
Network Exposure Function (NEF).
Network Repository Function (NRF).
Network Slice Admission Control Function (NSACF).
Network Slice-specific and SNPN Authentication and Authorization Function (NSSAAF).
Network Slice Selection Function (NSSF).
Policy Control Function (PCF).
Session Management Function (SMF).
Unified Data Management (UDM).
Unified Data Repository (UDR).
User Plane Function (UPF).
UE radio Capability Management Function (UCMF).
Application Function (AF).
User Equipment (UE).
(Radio) Access Network ((R)AN).
5G-Equipment Identity Register (5G-EIR).
Network Data Analytics Function (NWDAF).
CHarging Function (CHF).
Time Sensitive Networking AF (TSN AF).
Time Sensitive Communication and Time Synchronization Function (TSCTSF).
Data Collection Coordination Function (DCCF).
Analytics Data Repository Function (ADRF).
Messaging Framework Adaptor Function (MFAF).
Non-Seamless WLAN Offload Function (NSWOF).

NOTE: The functionalities provided by DCCF and/or ADRF can also be hosted by an NWDAF, example.
Edge Application Server Discovery Function (EASDF).

The 5G System architecture also comprises the following network entities:
Service Communication Proxy (SCP).
Security Edge Protection Proxy (SEPP).

The functional descriptions of these Network Functions and entities are specified in clause 6.
Non-3GPP InterWorking Function (N3IWF).
Trusted Non-3GPP Gateway Function (TNGF).
Wireline Access Gateway Function (W-AGF).

Trusted WLAN Interworking Function (TWIF).

It has been recognized that internet of things (IOT) and industrial internet of things (IIoT) applications may be different from conventional cellular application, e.g., in the context of 5G.

For example, IIoT may need to support various network topologies, such as start, ring, daisy chain (line), mesh, mixtures thereof, or the like.

In conventional cellular applications, a typical topology may be start topology (e.g. one base station sending to multiple terminal devices or user equipments (UE)), but in industrial communication, such as a factory floor, the topology may depend on a layout of a machine, requirements of communications, or the like.

It has further been recognized that known cellular systems may not be able to provide fail-safe communication, because known radio channels may be unstable and may have randomness. Retransmission may improve error rate, but also increase a delay, whereas a safety communication may need to work immediately at an event of emergency.

Furthermore, if wired communication is replaced with 5G wireless communication, it should (ideally) meet the requirements of wired communications. For example, the ring topology communication or mesh topology communication may be used if high reliable of the communication between the network devices is required, because such topologies may be able to communicate even if one of the link is deactivated. It has been recognized that it may be desirable that, in 5G, the same reliability requirements but with alternative technology may need to be met.

It has further been recognized that various type of communication may need to be supported.

In conventional industrial communication, there may be many communication modes/types because there may be many standards/products to meet the communication requirements for various industries, such as periodic/aperiodic, synchronous/asynchronous, deterministic/non-deterministic, cyclic/event driven/, realtime/non-realtime/isochronous, or the like.

It has been recognized that 5G TSN may need to be able to connect to them and/or replace wire-based solutions with wireless ones.

In the following, definitions of different communication types are given.

### Cyclic/Event Driven

In cyclic communication, the terminal devices (also referred to as user equipment (UE)) may be get information after one another. For example, UE A→UE B→UE C→UE D, then back to start, UE A. Time slots may be pre-allocated and guaranteed to use for the specific UE. For example, transmission may be based on time division, but also other transmission types may be envisaged. For example, resources may be separated in a frequency domain or in a special domain (e.g. beam domain) if transmissions overlap in a same time slot.

On the other hand, event driven is traffic may be handled when an event (e.g., an alarm) occurs, such that such communication may be referred to as “on-demand”. However, if low latency is required, such as for a critical alarm, the traffic may need to be handled immediately. Depending on the type of event/alarm, different strategies of traffic handling may be required. Even for delay tolerant events, a time stamp when an event occurs should be accurate because a historical log may be useful for trouble shooting.

### Deterministic/Non-Deterministic

In deterministic communication, uncertainty/randomness may be removed as much as possible. The factors of uncertainty may be avoided, such as a collision of resource usage (e.g. contention, interferences), effect of channel fading (error), shortage of transmission power in an amplifier, network node overload beyond the capacity, and the like. Deterministic communication may be provided by a combination of multiple technologies. For example, the cyclic communication or periodic resource allocation may be used to provide deterministic communication.

### Synchronous/Asynchronous

Asynchronous communication may have a different meaning depending on the context. In conventional LPWA IoT (delay tolerant system), a receiver may use the signal later after a UE sends the signal. The time when the data received may be much later than the time when the data is used.

In industrial IoT, such as factory automation, an unexpected, unplanned alarm may be raised. Such an alarm may be considered as asynchronous. However, urgency may depend on a type of event/alarm. Some events may be delay tolerant, but some events should be handled immediately.

In industrial IoT, both synchronous and asynchronous traffic may need to be handled.

### Realtime/Non-Realtime/Isochronous

In 3GPP context, realtime traffic may be used for voice, video, and the like. The realtime traffic may need to be handled within an allowed delay (e.g. for voice, latency may need to be less than 100 ms). Therefore, such traffic may be handled like voice over LTE (VoLTE). On the other hand, non-real time traffic may not require such handling.

It has been recognized that, in IIoT, a further traffic class may be needed which may be called “isochronous”. Isochronous communication may provide low latency communication, very accurate time synchronization, and high reliability. It may be suitable for industrial application like motion control. The 5G TSN may be a key technology to meet this requirement.

### Periodic/Aperiodic

In periodic communication, a signal may be transmitted in regular interval. For example, a UE may repeatedly transmit a signal every 5 ms, or the like.

As indicated above, in industrial communication, there may be various combination of the different communication types, which should also be usable in 5G. More information may be obtained from the white paper [2]

However, it has been recognized that no 3GPP standard defines how these different communication types should be taken into account by the TSN.

Moreover, it has been recognized that various types of use cases may be present in factory automation, which should still be usable in 5G IIoT. Such use cases may be shown in 3GPP TR 22.804 V16.3.0 (2020-07). In the following, some use cases are defined.

### Motion Control

In a factory, a motor/actuator may control objects to move to a predetermined position, with a predetermined speed, at a predetermined timing (e.g., conveyor belt, robots). This may be achieved based on sensors.

It has been recognized that such a system may have a feedback loop to adjust position/speed and it may require low latency, very accurate time synchronization and high reliability. It should be based on deterministic communication and may use cyclic communication to guarantee a quality of service (QoS).

### Alarm/Event

Alarm/events may occur at unexpected times. However, there may be various types of alarms/events. For example, an immediate action may be required for an alarm which shows an emergency situation. On the other hand, some events may be delay tolerant and as a first step, it may be sufficient to just record it in a log. However, in a conventional 3GPP, such diversity of events is not taken into account.

In addition, a very accurate time stamp may be required for events because a time series analysis may help with trouble-shooting.

### Non-Realtime Data

In a factory, a machine may be controlled by a computer (system), e.g., based on ERP, MES, SCADA. Large volumes of data may be trafficked, but such systems may need to be delay tolerant. In a factory environment, the real-time communication and non-realtime one may be mixing.

### Machine Vision

Machine vision may refer to a technology and to methods used to provide imaging-based automatic inspection and analysis for applications as automatic inspection, process control, robot guidance, and the like, e.g., in industry.

Video analytics and/or image processing may require handling of large volumes of data. A sensing result may need to be used for motion control (e.g., robot vision). In machine vision, eMBB type traffic and URLLC type traffic may be mixed in a system.

### Safety Communication

It has been recognized that for factory automation with 5G, it may be challenging to support safety control functions such as “emergency stop switch”, “Deadman's switch”, or the like, which may be designed to stop a machine if the human operator cannot operate it for some reason (e.g., loss of consciousness).

### Fail-Safe

Fail-safe may refer to a feature or practice that in case of a specific type of failure inherently responds in a way that will cause minimal or no harm to other equipment, environment and/or people.

### Safety Limited Speed (SLS) Function

A SLS function may cause controlled deceleration of, e.g., a motor, to a defined target speed. A drive may be decelerated to the predefined target speed, which may be monitored. SLS may thus prevent the motor to exceed the speed limit.

### Programmable Logic Controller (PLC)

A PLC may refer to an industrial computer that has been ruggedized and adapted for control of manufacturing processes, such as assembly lines, machines, robotic devices, or any activity that requires high reliability, ease of programming, process fault diagnosis, and the like.

It has been recognized that in industrial internet of things (IIoT), safety communication may require a special reliability mechanism because an error, failure, emergency, or the like, may cause a disastrous situation which could be a matter of life and death, such that it may be desirable to provide a fail-safe communication mechanism.

Such a fail-safe communication mechanism may be provided as follows:
a) UE (or gNB for downlink) may transmit a radio signal (or a plurality of signals) indicating a “normal status” in case of a normal operation. It should be noted that the UE (or terminal device) may indicate its own status or a status of one or more other devices (e.g., machines).
b) A transmitter (or the UE itself) may send the signal(s) cyclically/periodically during the “normal” operation.
c) A base station (e.g., gNB) (for uplink) (or UE for downlink) may regularly (i.e., cyclically or periodically) receive the signal(s) when the operation is “normal”.
d) At the event of error/failure/emergency, the gNB (or UE) does not receive the signal(s) anymore.
e) If there is something wrong with the link, the gNB (or UE) may miss the (consecutive) signal(s) (mis-detection), which may indicate an error/failure/emergency situation.

This is further discussed in the following under reference of FIG. 1.

FIG. 1 depicts a schematic diagram 1 for uplink communication, i.e., the transmitter is a UE (User Equipment) and the receiver is a base station (gNB). However, it is also possible to apply the concepts discussed herein for a downlink communication (i.e., base station is transmitter and UE is receiver).

In this embodiment, the UE is configured for cyclic (or periodic) communication. The resource is allocated in advance to transmit the cyclic (or periodic) signal.

As indicated in a time diagram 2, the UE transmits an “OK” signal indicating “normal” operation every three milliseconds. However, when an emergency button 3 is pushed/pressed by a user (as a mere example as how an error/failure/emergency can be indicated), the UE stops sending the “OK” signal, which is interpreted by the station as “not sent or missed” (since there may be other reasons that the base station does not receive the signal anymore, such as a blocking of a line of sight).

In this embodiment, in order to secure that an error/failure/emergency has happened, a required response time is defined which is ten milliseconds. This required response time allows for interpretation whether the error/failure/emergency really has happened or whether only a transmission error occurred. For example, if only one “OK” signal has been missed, due to a blocking of the line-of-sight between the UE and the base station, there would be no need to stop a machine or to initiate an emergency function since, for example, the next signal will likely not be missed anymore.

Hence, a threshold is defined in this embodiments which indicates, to the base station, the emergency situation when three “OK” signals have been missed.

It should be noted that this embodiment should not be understood as limiting since depending on the situation, the missing of one, two, or more than three signals may indicate the error/failure/emergency.

This may also depend on a cycle time. For example if the cycle time is two milliseconds (instead of three, as described above), five “OK” signals may need to be missed before the base station interprets this as the error/failure/emergency.

It has been recognized that, for uplink, the gNB may establish a configured grant (CG) for the UE with a specific period/cycle time.

It has been recognized that, for downlink, the gNB may configure semi-persistent scheduling (SPS) with the period/cycle time.

Therefore, some embodiments pertain to a user equipment (or user equipment (UE)) for a mobile telecommunications network, the user equipment including circuitry configured to: transmit, to a base station, a cyclic radio signal via a permanent channel, wherein the permanent channel (alternatively: keep alive channel) is established, by the base station, with a configured grant; and end transmission of the cyclic radio signal when an emergency function is activated.

There are some alternatives of emergency (or normal status) indication without cyclic signal. An example of status indication, UE sends the aperiodic radio signal for other purpose (e.g., channel state information) but if the interval between signals is longer than expected, UE may send the dummy signal to avoid the long interval.

Another example of status indication, UE sends the explicit indication of normal operation on the user data or control signalling if there are opportunity to send something. For example, the piggyback message or bit in other message/other signalling.

Another example of status indication, UE sends the implicit indication of normal operation if other message/signaling is sent. For example, UE sends the RRC signalling like measurement reports, CSI feedback like channel quality indicator (CQI), sounding reference signal (SRS), gNB interprets it as the UE normal operation.

Hence, some embodiments pertain to a user equipment for a mobile telecommunications network, the user equipment comprising circuitry configured to: transmit, to a base station, a signal of operation status indication, wherein the signal of operation status indication is transmitted within a predetermined time interval from a previous transmission of an operation status indication.

Likewise, some embodiments pertain to a user equipment for a mobile telecommunications network, the user equipment comprising circuitry configured to: receive, from a base station, with allocated resources an emergency indication; and carry out an emergency action in response to receiving the emergency indication.

Moreover, some embodiments pertain to a base station for a mobile telecommunications network, the base station comprising circuitry configured to: receive, from the user equipment, a signal of operation status indication, wherein the signal of operation status indication is transmitted within a predetermined time interval from a previous transmission of an operation status indication.

Also, some embodiments pertain to a base station for a mobile telecommunications network, the base station comprising circuitry configured to: send, to a user equipment, with allocated resources an emergency indication.

Accordingly, corresponding methods for the UEs and base stations are provided, as well as additional aspects, as described below.

The CG may allow share resources between different UEs. However, since a fail-safe signal is required, in some embodiments, no conflicts should exist among the UEs. Thus, the gNB (base station) should allocate dedicated (exclusive) resources for each UE, in some embodiments.

Moreover, in order to minimize resources, the safety signal is reduced only to the indication of the “normal” (or “OK”) status, as described above. Hence, in some embodiments, the cyclic radio signal indicates a normal operation mode (e.g., of the user equipment itself and/or of at least one different user equipment).

In some embodiments, power boosting and/or signal repetition techniques (e.g., TTI bundling) are applied for reducing retransmission and/or communication error. TTI bundling may refer to a UE transmitting consecutive packet within a transmission time interval (TTI) (e.g., one transmission). Thereby, a chance of retransmission is reduced since retransmission may cause delay.

As indicated above, under reference to FIG. 1, the UE may stop transmitting the “normal” signal to the gNB in case of emergency. If the base station does not receive the signal for consecutive expected (time) slots, the gNB determines that an emergency is at hand.

A number of consecutive slots and their time period may be determined based on requirements of the signal (e.g., maximum allowed delay, required response time, or the like). A decision of whether an alarm should be generated may be made after consecutive slots are not received, such that a chance of false alarm may be reduced. As indicated above, a false alarm may, for example, be generated due to signal fading, blocking of line of sight (e.g., due to an obstacle), or the like.

In some embodiments, the UE is further configured to send additional information when the emergency function is activated (after the transmission of the cyclic signal is ended).

In some embodiments, the additional information includes at least one of an indication of an occurrence (e.g., type and/or origin of emergency) and/or a timestamp (i.e., when the emergency function is activated).

In some embodiments, the additional information is sent with separate resources, i.e., resources which are different from the resources in which the cyclic signal is sent. Hence, in some embodiments, the additional information is sent on a different channel than the permanent channel. This may be due to the circumstance that the cyclic signal may require very low resources (as described above) and thus, there may be no room to convey the additional information via that channel.

In some embodiments, the circuitry is further configured to: receive, from the base station, via semi-persistent scheduling, an emergency indication; and carry out an emergency action in response to receiving the emergency indication.

For example, the emergency indication may include a course of action which should be taken when the emergency is detected. The emergency indication may cause a (predefined) emergency action (e.g., stopping/slowing down of a machine) to be carried out.

In some embodiments, the base station is, in case of missing the “normal” signal, further configured to stop other transmission/reception which is not related to the error/failure/emergency and allocates a predetermined amount (e.g., all) resources to handle the additional information for the safety procedure.

In some embodiments, the network is configured to provide time-sensitive communication with the user equipment, as discussed herein.

In some embodiments, the mobile telecommunications network is a 5G network, as discussed herein.

In some embodiments, the mobile telecommunications network is an industrial internet of things network, as discussed herein.

In some embodiments, the mobile telecommunications network is a 5G industrial internet of things network, as discussed herein.

Some embodiments pertain to a base station for a mobile telecommunications network, the base station including circuitry configured to: establish, to the user equipment, a permanent channel with a configured grant; receive, from the user equipment, a cyclic radio signal via the permanent channel; and detect an emergency when the base station misses a predetermined number of expected cycles of the cyclic radio signal.

In some embodiments, the cyclic radio signal indicates a normal operation mode, as discussed herein.

In some embodiments, the circuitry is further configured to: send, via semi-persistent scheduling, an emergency indication.

The emergency indication may be sent to the UE (or terminal device) or to a different entity. For example, the UE may be configured to surveil the different entity (e.g., machine), such that the emergency indication may be sent to the machine directly. On the other hand, the UE may receive the emergency indication.

In some embodiments, the network is configured to provide time-sensitive communication, as discussed herein.

In some embodiments, the circuitry is further configured to: receive additional information from the user equipment when an emergency function is activated on the user equipment, as discussed herein. In some embodiments, the additional information includes at least one of an indication of an occurrence and a timestamp, as discussed herein. In some embodiments, the additional information is received on a different channel than the permanent channel, as discussed herein.

In some embodiments, the circuitry is further configured to: establish a configured grant for a plurality of user equipments.

In some embodiments, the circuitry is further configured to: allocate dedicated resources for each of the plurality of user equipments.

As indicated above, the CG may to allow share resources between different UEs. However, since a fail-safe signal is required, in some embodiments, no conflicts should exist among the UEs. Thus, the gNB (base station) should allocate dedicated (exclusive) resources for each UE, in some embodiments.

Hence, in some embodiments, the base station is, in case of missing the “normal” signal, further configured to stop other transmission/reception which is not related to the error/failure/emergency and allocates a predetermined amount (e.g., all) resources to handle the additional information for the safety procedure.

Accordingly, in some embodiments, the circuitry is further configured to: re-allocate a predetermined amount of resources for handling the emergency.

In some embodiments, the mobile telecommunications network is a 5G network, as discussed herein. In some embodiments, the mobile telecommunications network is an industrial internet of things network, as discussed herein. In some embodiments, the mobile telecommunications network is a 5G industrial internet of things network, as discussed herein.

Some embodiments pertain to a method carried out in a user equipment for a mobile telecommunications network, the method including: transmitting, to a base station, a cyclic radio signal via a permanent channel, wherein the permanent channel is established, by the base station, with a configured grant; and ending transmission of the cyclic radio signal when an emergency function is activated, as discussed herein.

In some embodiments, the cyclic radio signal indicates a normal operation mode, as discussed herein. In some embodiments, the method further includes: receiving, from the base station, via semi-persistent scheduling, an emergency indication; and carrying out an emergency action in response to receiving the emergency indication, as discussed herein. In some embodiments, the network is configured to provide time-sensitive communication with the user equipment, as discussed herein. In some embodiments, the method further includes: sending additional information when the emergency function is activated, as discussed herein. In some embodiments, the additional information includes at least one of an indication of an occurrence and a timestamp, as discussed herein. In some embodiments, the additional information is sent on a different channel than the permanent channel, as discussed herein. In some embodiments, the cyclic radio signal is transmitted based on at least one of power boosting and signal repetition, as discussed herein. In some embodiments, the mobile telecommunications network is a 5G network, as discussed herein. In some embodiments, the mobile telecommunications network is an industrial internet of things network, as discussed herein. In some embodiments, the mobile telecommunications network is a 5G industrial internet of things network, as discussed herein.

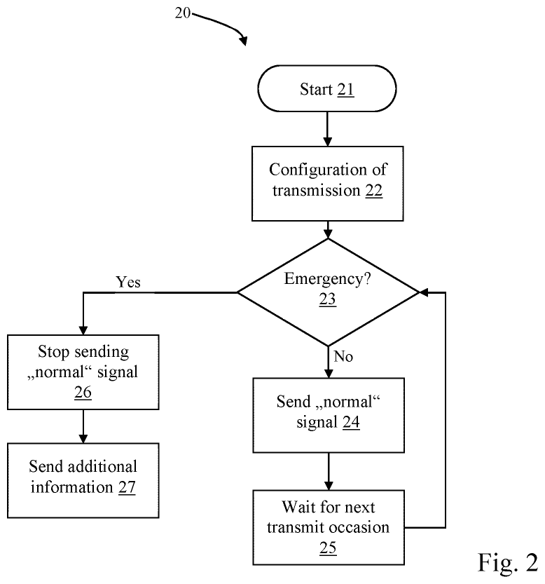

FIG. 2 depicts a method 20 according to the present disclosure which is carried out in a transmitter (e.g., UE).

At 21, the method starts.

At 22, the transmission is configured, i.e., a configured grant is requested to a base station.

At 23, it is checked, whether an emergency is present.

If not, at 24, a “normal” signal is sent, as discussed herein.

After that, at 25, it is waited for the next transmit occasion and again, it is checked, at 23, whether an emergency is present.

If an emergency is present, at 26, the sending of the “normal” signal is stopped.

At 27, additional information is sent, as discussed herein.

Some embodiments pertain to a method carried out in a base station for a mobile telecommunications network, the method including: establishing, to the user equipment, a permanent channel with a configured grant; receiving, from the user equipment, a cyclic radio signal via the permanent channel; and detecting an emergency when the base station misses a predetermined number of expected cycles of the cyclic radio signal, as discussed herein.

In some embodiments, the cyclic radio signal indicates a normal operation mode, as discussed herein. In some embodiments, the method further includes: sending, via semi-persistent scheduling, an emergency indication, as discussed herein. In some embodiments, the network is configured to provide time-sensitive communication, as discussed herein. In some embodiments, the method further includes: receiving additional information from the user equipment when an emergency function is activated on the user equipment, as discussed herein. In some embodiments, the additional information includes at least one of an indication of an occurrence and a timestamp, as discussed herein. In some embodiments, the additional information is received on a different channel than the permanent channel, as discussed herein. In some embodiments, the method further includes: establishing a configured grant for a plurality of user equipments, as discussed herein. In some embodiments, the method further includes: allocating dedicated resources for each of the plurality of user equipments, as discussed herein. In some embodiments, the method further includes: re-allocating a predetermined amount of resources for handling the emergency, as discussed herein. In some embodiments, the mobile telecommunications network is a 5G network, as discussed herein. In some embodiments, the mobile telecommunications network is an industrial internet of things network, as discussed herein. In some embodiments, the mobile telecommunications network is a 5G industrial internet of things network.

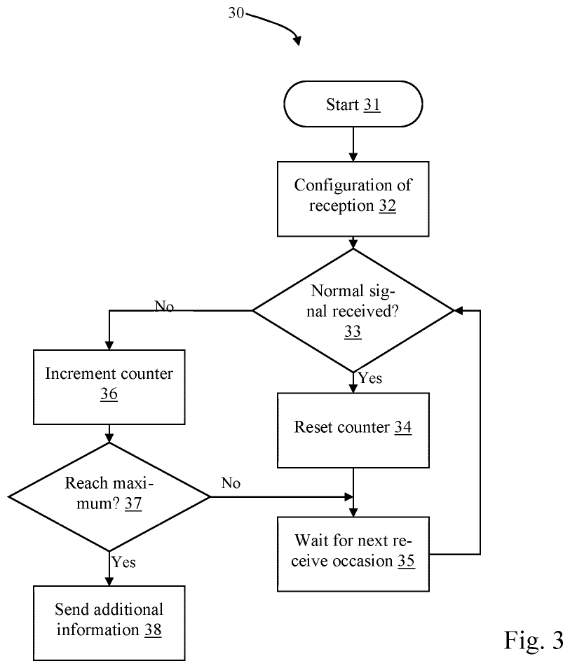

FIG. 3 depicts a method 30 which is carried out in a receiver (e.g., base station).

At 31, the method starts. A transmission period and detection condition (e.g., a counter value=may be based on an error rate or mis-detection rate and/or a maximum allowed delay, as discussed herein.

At 32, reception is configured, i.e., a configured grant is established, as discussed herein.

At 33, it is checked, whether a “normal” signal is received.

If yes, at 34, a counter is reset.

At 35, it is waited for a next receive occasion and it is checked, at 33, whether the normal signal is received.

If the normal signal is not received, the counter is incremented, at 36.

At 37, it is decided whether a maximum counter number is reached.

If not, the method goes to 35, i.e., it is waited for the next receive occasion.

If again no normal signal is received, at 33, and the counter is increment and reaches its maximum, at 38, an emergency action is initiated. The action may be pre-configured by an operation and maintenance (O&M) tool and/or time-sensitive communication assistance information (TSCAI) may be sent together with an emergency indication, as discussed herein.

It should be noted that the determination of missed cycles may be embodied differently than with a counter, e.g., with a timer, as may be apparent to the person skilled in the art.

In some embodiments, the base station indicates the emergency to an application (e.g., server, cloud, edge computer) via a 5G core network.

In some embodiments, the base station indicates the emergency to other UEs via at least one of broadcast, multicast, or the like.

In some embodiments, the gNB indicates the emergency to other UEs via unicast.

Some embodiments pertain to a mobile telecommunications network comprising a user equipment, a base station, and circuitry configured to: establish, by the base station, a permanent channel with a configured grant; transmit, from the user equipment to the base station, a cyclic radio signal via the permanent channel; end transmission of the cyclic radio signal when an emergency function is activated; and detect, by the base station, an emergency when the base station misses a predetermined number of expected cycles of the cyclic radio signal, as discussed herein.

It has been recognized that machine vision may be utilized for detecting an emergency situation.

Machine vision may refer to a combination of camera/image sensor and image/video processing. In a conventional surveillance camera, a human may need to monitor a screen. However, in machine vision, the machine may automatically recognize the situation and may indicate an action, if necessary. Machine vision may therefore need to support mixed types of traffic like video/still image data, alarm/event, and indication to other devices, indication to humans (e.g., with text), and the like.

Safety-limited speed (SLS) may require multi-level control of a machine speed to prevent an accident, e.g., in case a human and a robot work together.

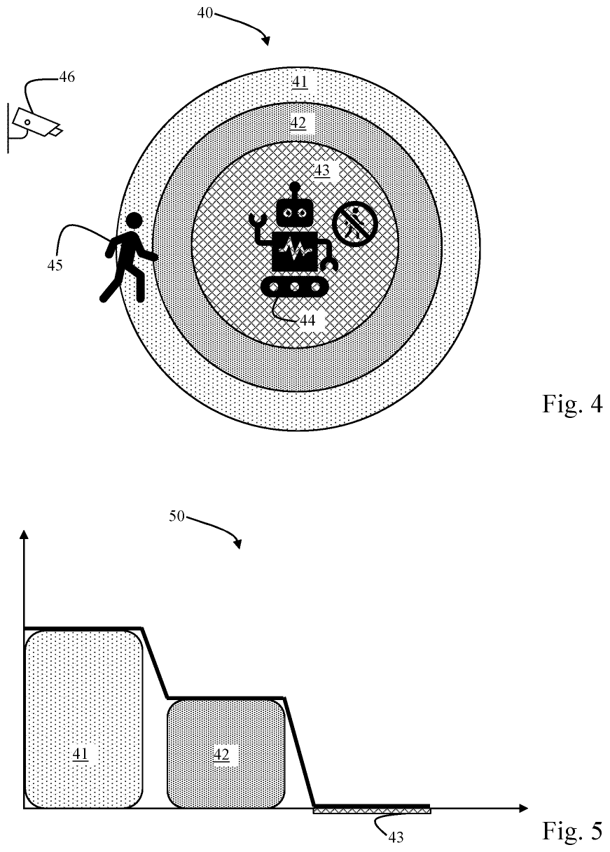

FIG. 4 depicts an SLS range 40 in according to an embodiment of the present disclosure.

A first sub-range 41 is considered to be sufficiently far away from a robot 44, such that the robot 44 can work normally when a human 45 is within the first sub-range 41.

If the human 45 is approaching to the robot 44, within a second sub-range 42 (low-risk range), the robot 44 is configured to slow down its operation speed, such that an immediate stop (if necessary) can be achieved more easily.

If the human 45 enters the third sub-range 43 (high-risk range), the robot 44 is configured to stop immediately.

In this embodiment, detection in which range the human 45 is present, is carried out with a camera 46, but also the robot 44 may be configured to surveil its environment and thereby detect the human 45.

A velocity diagram 50 of the robot's 44 operation speed is shown in FIG. 5 schematically depicting, on the ordinate, a velocity vis-à-vis the ranges 41 to 43, as described under reference of FIG. 4. A can be taken from FIG. 5, the robot 44 slows down when the human 45 is approaching (i.e., is within the range 42) and immediately stops when the human 45 is within the range 43.

The range 42 also serves as a viewing-range, in which the human 45 can monitor the robot's 44 behavior, e.g., for maintenance or configuration.

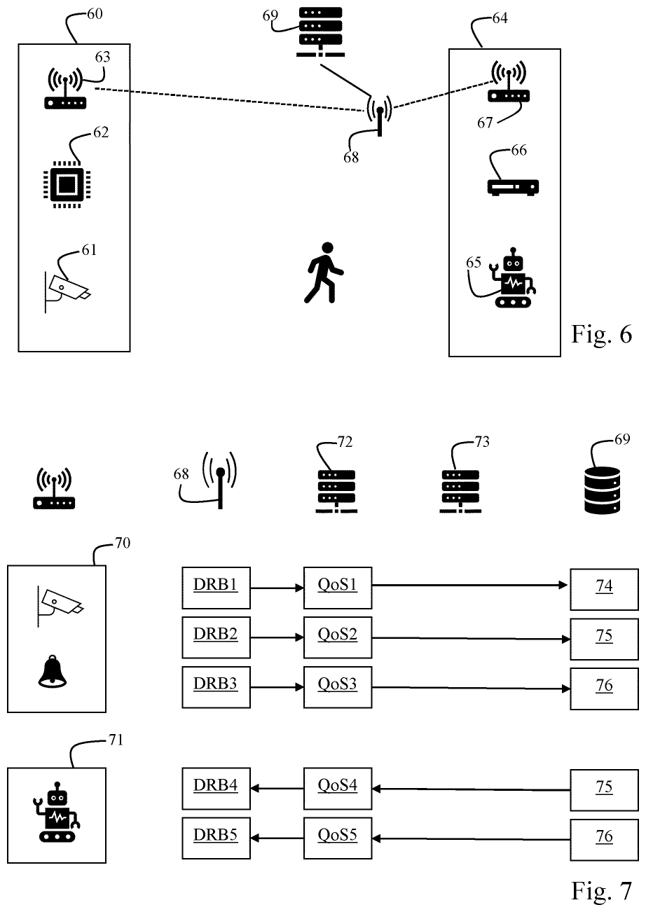

A block diagram of a mobile telecommunications network for providing machine vision and an SLS function is discussed in the following under reference of FIG. 6.

The network includes a machine vision system 60, an SLS system 64, and a base station 68.

The machine vision system 60 includes a camera 61, an edge computer 62, and a UE 63.

The edge computer 62 is configured to analyze a video from the camera 61 and to recognize objects in the video, to calculate distances between objects in the video, and the like. The UE 63 is configured to send an alarm based on video analysis. Moreover, the UE 63 may send the video data for recording and monitoring purpose to a different place (e.g., control centre).

The SLS system 64 includes a target machine 65 (e.g., robot), a controller 66 (e.g., programmable logic controller, PLC), and a UE 67.

In response to receiving an alarm or command from base station 68 and/or a network server/cloud 69, the UE 67 informs the PLC 66, which is configured to control a speed of the machine 65.

As indicated above, the 5G system of FIG. 6 includes at least one base station (gNB), a core network nodes (e.g., UPF, not shown), which connects the server 69, which is in charge of administration of factory shop floor, in this embodiment, with the machine vision system 60 and the SLS system 64.

Based on such a system, quality of service (QoS) flows may be defined for different entities, as discussed in the following under reference of FIG. 7.

FIG. 7 depicts, on a machine vision side 70, UEs which are used for a machine vision application (in this embodiment, a camera, and an alarm). On an SLS side 71, a machine (e.g., robot) is depicted.

As indicated above, the network further includes a base station 68 and a server/cloud 69. Moreover, a UPF 72 (as described above), and a network node 73 implementing a time-sensitive network application function (TSN-AF) is shown.

From the machine vision side 70 to the server/cloud 69, the uplink streams are established, which include different type of traffics. Video data for recoding and monitoring (e.g., by a human in control centre) is handled via non-realtime (eMBB) traffic, as indicated by DRB1/QoS1. On the other hand, the alarm/event is handled via realtime traffic (URLLC).

Depending on a type of alarm/event, a level of severity, different streams are used as indicated by DRB2/QoS2 and DRB3/QoS3. If the alarm/event indicates a medium risk (DRB2/QoS2), conventional URLLC QoS (Quality of Service) configuration used. If the alarm/event indicates a high risk (DRB3/QoS3), a cyclic URLLC configuration for safety communication is configured because it must stop the machine immediately. This may be realized as discussed above, under reference of FIGS. 1 to 3.

The QoS flow/DRB separation is used for dividing the traffic into different types. For example, the large volume of alarms/events are likely to be generated in case of severe incident in a factory. Thereby, high risk/critical alarms are prioritized over the normal/not so critical alarms.

The server/cloud 69 receives non-realtime traffic 74 with the QoS Flow 1 (QoS1), alarms/events 75 with the QoS Flow 2 (QoS2), and an emergency stop command 76 with the QoS Flow 3 (QoS3).

From the server/cloud 69, the UE on the SLS side 71 receives one or more streams (e.g., streams 74 and 75) for alarm/event/command reception (indicated with DRB4/QoS4 and DRB5/QoS5). Similar to the uplink stream, the alarm/event for medium risk (DRB4/QoS4) utilizes the conventional URLLC QoS configuration, but the alarm/event for a high risk (DRB5/QoS5) utilizes the cyclic URLLC configuration for safety communication.

Note that if high traffic volume is not expected, the UE may use one QoS flow/DRB with higher QoS requirements instead of two separate ones.

In case a single QoS flow or DRB carries both high priority and low priority traffic, then high priority traffic is prioritized, in some embodiments. Low priority traffic is then either discarded or transmitted after the high priority traffic is sent.

If a sidelink is available, the machine vision UE may directly send the alarm/command to the target SLS UE.

Hence, in some embodiments, separate DRB/QoS flows are established for the same UE, i.e., in this embodiment, for non-realtime traffic and safety communication. Moreover, different QoS flows in core network and DRB are established depending on a criticality of an alarm/event.

Moreover, depending on a level of risk, negative impact if missed, and the like, fail-safe communication is applied for the DRB/QoS flow.

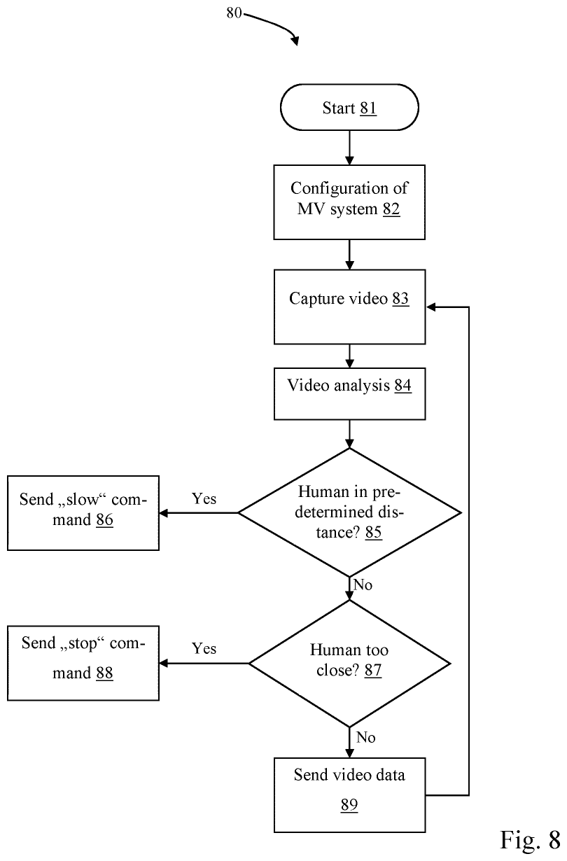

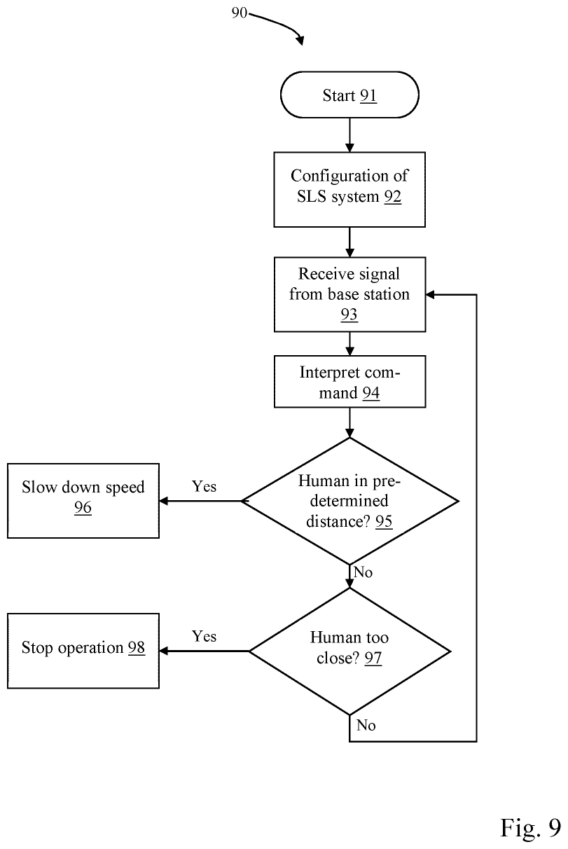

FIG. 8 depicts a method 80 which is carried out on the machine vision (MV) side 70.

At 81, the method starts.

At 82, the MV system is configured by a base station. For example, a non-realtime QoS flow QoS1 is configured for the video stream (e.g., 5QI is set to 67: Mission Critical Video user plane). Moreover, the QoS2 flow may be configured as 5QI=82 (discrete automation), i.e., has ten milliseconds latency, but only 255 bytes of data available.

The QoS3 flow may be configured based on a specially defined 5QI requirement (which is not standardized yet) or based on TSCAI in order to realize a critical message or an emergency stop.

At 83, a video is captured and passed to an edge computer which analyzes the video, at 84. The video analysis may include recognizing objects and determining distances between the objects.

At 85, it is evaluated whether a human is within a predetermined distance (e.g., medium risk area).

If it is recognized, at 86, based on the video analysis, that a human is in a medium risk area (e.g., area 42, as described above), an alarm/event is sent based on QoS2 flow.

If the human is not within area 42, it is checked whether the human is too close to the machine, at 87.

If yes, a “stop” command is sent via QoS3 flow, at 88. If not, video data is sent to the server/cloud 69, via QoS1 flow.

At 91, the method starts.

At 92, the SLS system is configured, as discussed above.

At 93, the UE receives a signal (command) from the base station.

At 94, the PLC interprets the command.

First, it is checked, at 95, whether the human is within the predetermined distance (e.g., area 42). If yes, at 96, the speed of the machine is slowed down. If a communication error is detected, the base station may also indicate to slow down the speed.

Moreover, the base station may change resource allocation/scheduling for higher reliability and low latency (e.g., based on a reconfiguration of SPS/CG, as discussed above).

If the decision of 95 results in “NO”, at 97, it is checked whether the human is too close (e.g., in area 43).

If yes, at 98, the operation is stopped. If no, the method goes back to 93.

Hence, ins some embodiments, depending on a level of risk (e.g., range), the gNB may change a strategy of resource allocation/scheduling.

The gNB may configured separate DRBs/QoS flows (or combined DRB/QoS) flow in line with different QoS requirements.

In a more general manner: Some embodiments pertain to a user equipment for a mobile telecommunications network, the user equipment including circuitry configured to: obtain surveillance data; input the surveillance data into a machine vision algorithm; determine a level of risk attributed to the surveillance data based on the machine vision algorithm; and send, on a permanent channel which is established between the user equipment and a communication network node, an emergency command, if the level of risk exceeds a predetermined threshold.

In some embodiments, the circuitry is further configured to: send the emergency command on a predefined quality of service flow, as discussed herein.

In some embodiments, the predefined quality of service flow is defined as safety communication.

In some embodiments, the circuitry is further configured to: prioritize the emergency command over data which are to be sent on a different quality of service flow, as discussed herein.

According to the present disclosure, there may be some methods on how to prioritize the emergency commands/safety communication over normal message.

In some embodiments, the base station (e.g., gNB) may configure different logical channels with different logical channel priority (LCP). When a UE sends an emergency command message, the logical channel for the emergency command message is prioritized over the logical channel for normal message, for example.

In some embodiments, the base station may configure a PHY-priority (according to the RRC parameter, “Ich-basedPrioritization”), UE may prioritize the physical channel for emergency commands/safety communication over a normal message, or the like.

In some embodiments, UE adds a priority bit in any of the headers of PDCP/RLC and MAC layer. Even if emergency data is shared with normal data on the same logical channel, this solution may be applicable. When this bit in header is found then all remaining packets are discarded in the buffer and this packet is transmitted.

In some embodiments, the circuitry is further configured to: send, via the communication network node, a data stream on a different quality of service flow when it is determined that the level of risk is below the predetermined threshold, as discussed herein. In some embodiments, the data stream is sent on a different channel than the permanent channel, as discussed herein.

In some embodiments, the quality of service flow is based on a quality of service definition.

For example, a 5QI definition may be used, as apparent to the skilled person. However, according to the present disclosure, such an existing definition may be re-used or overwritten with a definition that better suits the circumstances.

In some embodiments, the quality of service definition is based on at least one of an application of the user equipment, a safety requirement, a communication type, a latency, a packet error rate, and a redundancy path requirement.

In some embodiments, the quality of service definition is based on RAN assistance information.

In some embodiments, RAN assistance information is used to override an existing quality of service definition.

In some embodiments, the circuitry is further configured to: override the existing quality of service definition based on an application requirement of the user equipment, as discussed herein.

In some embodiments, the permanent channel is a cyclic channel, as discussed herein.

In some embodiments, the cyclic channel is an ultra reliable low latency communication, URLLC, channel, as discussed herein. In some embodiments, the emergency command indicates a machine to slow down its operation speed or to stop its operation, as discussed herein. In some embodiments, the emergency command indicates the machine to slow down its operation when it is recognized that a distance between a human and the machine is within a predetermined range, as discussed herein. In some embodiments, the emergency command indicates the machine to stop its operation when it is recognized that a distance between the human and the machine is below the predetermined range, as discussed herein. In some embodiments, the mobile telecommunications network is a 5G network, as discussed herein. In some embodiments, the mobile telecommunications network is an industrial internet of things network, as discussed herein. In some embodiments, the mobile telecommunications network is a 5G industrial internet of things network, as discussed herein. In some embodiments, the communication network node is a server, as discussed herein. In some embodiments, the server is a cloud server, as discussed herein. In some embodiments, the server is a factory server, as discussed herein.

Some embodiments pertain to a communication network node for a mobile telecommunications network, the user equipment comprising circuitry configured to: receive, via a permanent channel which is established between the communication network node and a user equipment, an emergency command from the user equipment; and forward, on a permanent channel which is established between the communication network node and a user equipment, the emergency command, as discussed herein.

In some embodiments, the circuitry is further configured to: receive the emergency command on a predefined quality of service flow, as discussed herein. In some embodiments, the predefined quality of service flow is defined as safety communication, as discussed herein. In some embodiments, the circuitry is further configured to: prioritize the emergency command over data which are to be sent on a different quality of service flow, as discussed herein. In some embodiments, the quality of service flow is based on a quality of service definition, as discussed herein. In some embodiments, the quality of service definition is based on at least one of an application of the user equipment, a safety requirement, a communication type, a latency, a packet error rate, and a redundancy path requirement, as discussed herein. In some embodiments, the quality of service definition is based on RAN assistance information, as discussed herein. In some embodiments, the RAN assistance information is used to override an existing quality of service definition, as discussed herein. In some embodiments, the circuitry is further configured to: override the existing quality of service definition based on an application requirement of the user equipment, as discussed herein. In some embodiments, the permanent channel is a cyclic channel, as discussed herein. In some embodiments, the cyclic channel is an ultra reliable low latency communication, URLLC, channel, as discussed herein. In some embodiments, the emergency command indicates a machine to slow down its operation speed or to stop its operation, as discussed herein. In some embodiments, the emergency command indicates the machine to slow down its operation when it is recognized that a distance between a human and the machine is within a predetermined range, as discussed herein. In some embodiments, the emergency command indicates the machine to stop its operation when it is recognized that a distance between the human and the machine is below the predetermined range, as discussed herein. In some embodiments, the mobile telecommunications network is a 5G network, as discussed herein. In some embodiments, the mobile telecommunications network is an industrial internet of things network, as discussed herein. In some embodiments, the mobile telecommunications network is a 5G industrial internet of things network, as discussed herein. In some embodiments, the communication network node is a server, as discussed herein. In some embodiments, the server is a cloud server, as discussed herein. In some embodiments, the server is a factory server, as discussed herein.

Some embodiments pertain to a method carried out in a user equipment for a mobile telecommunications network, the method including: obtaining surveillance data; inputting the surveillance data into a machine vision algorithm; determining a level of risk attributed to the surveillance data based on the machine vision algorithm; and sending, on a permanent channel which is established between the user equipment and a communication network node, an emergency command, if the level of risk exceeds a predetermined threshold, as discussed herein. In some embodiments, the method further includes: sending the emergency command on a predefined quality of service flow, as discussed herein. In some embodiments, the predefined quality of service flow is defined as safety communication, as discussed herein. In some embodiments, the method further includes: prioritizing the emergency command over data which are to be sent on a different quality of service flow, as discussed herein. In some embodiments, the method further includes: sending, via the communication network node, a data stream on a different quality of service flow when it is determined that the level of risk is below the predetermined threshold, as discussed herein. In some embodiments, the data stream is sent on a different channel than the permanent channel, as discussed herein. In some embodiments, the quality of service flow is based on a quality of service definition, as discussed herein. In some embodiments, the quality of service definition is based on at least one of an application of the user equipment, a safety requirement, a communication type, a latency, a packet error rate, and a redundancy path requirement, as discussed herein. In some embodiments, the quality of service definition is based on RAN assistance information, as discussed herein. In some embodiments, the RAN assistance information is used to override an existing quality of service definition, as discussed herein. In some embodiments, the method further includes: overriding the existing quality of service definition based on an application requirement of the user equipment, as discussed herein. In some embodiments, the permanent channel is a cyclic channel, as discussed herein. In some embodiments, the cyclic channel is an ultra reliable low latency communication, URLLC, channel, as discussed herein. In some embodiments, the emergency command indicates a machine to slow down its operation speed or to stop its operation, as discussed herein. In some embodiments, the emergency command indicates the machine to slow down its operation when it is recognized that a distance between a human and the machine is within a predetermined range, as discussed herein. In some embodiments, the emergency command indicates the machine to stop its operation when it is recognized that a distance between the human and the machine is below the predetermined range, as discussed herein. In some embodiments, the mobile telecommunications network is a 5G network, as discussed herein. In some embodiments, the mobile telecommunications network is an industrial internet of things network, as discussed herein. In some embodiments, the mobile telecommunications network is a 5G industrial internet of things network, as discussed herein. In some embodiments, the communication network node is a server, as discussed herein. In some embodiments, the server is a cloud server, as discussed herein. In some embodiments, the server is a factory server, as discussed herein.

Some embodiments pertain to a method carried out in a communication network node for a mobile telecommunications network, the method including: receiving, via a permanent channel which is established between the communication network node and a user equipment, an emergency command from the user equipment; forwarding, on a permanent channel which is established between the communication network node and a user equipment, the emergency command.

In some embodiments, the method further includes: receiving the emergency command on a predefined quality of service flow, as discussed herein. In some embodiments, the predefined quality of service flow is defined as safety communication, as discussed herein. In some embodiments, the method further includes: prioritizing the emergency command over data which are to be sent on a different quality of service flow, as discussed herein. In some embodiments, the quality of service flow is based on a quality of service definition, as discussed herein. In some embodiments, the quality of service definition is based on at least one of an application of the user equipment, a safety requirement, a communication type, a latency, a packet error rate, and a redundancy path requirement, as discussed herein. In some embodiments, the quality of service definition is based on RAN assistance information, as discussed herein. In some embodiments, the RAN assistance information is used to override an existing quality of service definition, as discussed herein. In some embodiments, the method further includes: overriding the existing quality of service definition based on an application requirement of the user equipment, as discussed herein. In some embodiments, the permanent channel is a cyclic channel, as discussed herein. In some embodiments, the cyclic channel is an ultra reliable low latency communication, URLLC, channel, as discussed herein. In some embodiments, the emergency command indicates a machine to slow down its operation speed or to stop its operation, as discussed herein. In some embodiments, the emergency command indicates the machine to slow down its operation when it is recognized that a distance between a human and the machine is within a predetermined range, as discussed herein. In some embodiments, the emergency command indicates the machine to stop its operation when it is recognized that a distance between the human and the machine is below the predetermined range, as discussed herein. In some embodiments, the mobile telecommunications network is a 5G network, as discussed herein. In some embodiments, the mobile telecommunications network is an industrial internet of things network, as discussed herein. In some embodiments, the mobile telecommunications network is a 5G industrial internet of things network, as discussed herein. In some embodiments, the communication network node is a server, as discussed herein. In some embodiments, the server is a cloud server, as discussed herein. In some embodiments, the server is a factory server, as discussed herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

It should be recognized that the embodiments describe methods with an exemplary ordering of method steps. The specific ordering of method steps is however given for illustrative purposes only and should not be construed as binding. For example the ordering of 26, 27 and 24, 25 in the embodiment of FIG. 2 may be exchanged. Also, the ordering of 36 to 38 and 34, 35 in the embodiment of FIG. 3 may be exchanged. Further, also the ordering of 82 and 83 in the embodiment of FIG. 8 may be exchanged. Other changes of the ordering of method steps may be apparent to the skilled person.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) A user equipment for a mobile telecommunications network, the user equipment comprising circuitry configured to:
transmit, to a base station, a cyclic radio signal via a permanent channel, wherein the permanent channel is established, by the base station, with a configured grant; and
end transmission of the cyclic radio signal when an emergency function is activated.

(2) The user equipment of (1), wherein the cyclic radio signal indicates a normal operation mode.

(3) The user equipment of (1) or (2), further configured to:
receive, from the base station, via semi-persistent scheduling, an emergency indication; and
carry out an emergency action in response to receiving the emergency indication.

(4) The user equipment of anyone of (1) to (3), wherein the network is configured to provide time-sensitive communication with the user equipment.

(5) The user equipment of anyone of (1) to (4), wherein the circuitry is further configured to:
send additional information when the emergency function is activated.

(6) The user equipment of (5), wherein the additional information includes at least one of an indication of an occurrence and a timestamp.

(7) The user equipment of (5) or (6), wherein the additional information is sent on a different channel than the permanent channel.

(8) The user equipment of anyone of (1) to (7), wherein the cyclic radio signal is transmitted based on at least one of power boosting and signal repetition.

(9) The user equipment of anyone of (1) to (8), wherein the mobile telecommunications network is a 5G network.

(10) The user equipment of anyone of (1) to (9), wherein the mobile telecommunications network is an industrial internet of things network.

(11) The user equipment of anyone of (1) to (10), wherein the mobile telecommunications network is a 5G industrial internet of things network.

(12) A base station for a mobile telecommunications network, the base station comprising circuitry configured to:
establish, to the user equipment, a permanent channel with a configured grant;
receive, from the user equipment, a cyclic radio signal via the permanent channel; and
detect an emergency when the base station misses a predetermined number of expected cycles of the cyclic radio signal.

(13) The base station of (12), wherein the cyclic radio signal indicates a normal operation mode.

(14) The base station of (12) or (13), wherein the circuitry is further configured to:
send, via semi-persistent scheduling, an emergency indication.

(15) The base station of anyone of (12) to (14), wherein the network is configured to provide time-sensitive communication.

(16) The base station of anyone of (12) to (15), wherein the circuitry is further configured to:
receive additional information from the user equipment when an emergency function is activated on the user equipment.

(17) The base station of (16), wherein the additional information includes at least one of an indication of an occurrence and a timestamp.

(18) The base station of (16) or (17), wherein the additional information is received on a different channel than the permanent channel.

(19) The base station of anyone of (12) to (18), wherein the circuitry is further configured to:
establish a configured grant for a plurality of user equipments.

(20) The base station of (19), wherein the circuitry is further configured to:
allocate dedicated resources for each of the plurality of user equipments.

(21) The base station of anyone of (12) to (20), wherein the circuitry is further configured to:
re-allocate a predetermined amount of resources for handling the emergency.

(22) The base station of anyone of (12) to (21), wherein the mobile telecommunications network is a 5G network.

(23) The base station of anyone of (12) to (22), wherein the mobile telecommunications network is an industrial internet of things network.

(24) The base station of anyone of (12) to (23), wherein the mobile telecommunications network is a 5G industrial internet of things network.

(25) A method carried out in a user equipment for a mobile telecommunications network, the method comprising:
transmitting, to a base station, a cyclic radio signal via a permanent channel, wherein the permanent channel is established, by the base station, with a configured grant; and
ending transmission of the cyclic radio signal when an emergency function is activated.

(26) The method of (25), wherein the cyclic radio signal indicates a normal operation mode.

(27) The method of (25) or (26), further comprising:
receiving, from the base station, via semi-persistent scheduling, an emergency indication; and
carrying out an emergency action in response to receiving the emergency indication.

(28) The method of anyone of (25) to (27), wherein the network is configured to provide time-sensitive communication with the user equipment.

(29) The method of anyone of (25) to (28), further comprising:
sending additional information when the emergency function is activated.

(30) The method of (29), wherein the additional information includes at least one of an indication of an occurrence and a timestamp.

(31) The method of (29) or (30), wherein the additional information is sent on a different channel than the permanent channel.

(32) The method of anyone of (25) to (31), wherein the cyclic radio signal is transmitted based on at least one of power boosting and signal repetition.

(33) The method of anyone of (25) to (32), wherein the mobile telecommunications network is a 5G network.

(34) The method of anyone of (25) to (33), wherein the mobile telecommunications network is an industrial internet of things network.

(35) The method of anyone of (25) to (34), wherein the mobile telecommunications network is a 5G industrial internet of things network.

(36) A method carried out in a base station for a mobile telecommunications network, the method comprising:
establishing, to the user equipment, a permanent channel with a configured grant;
receiving, from the user equipment, a cyclic radio signal via the permanent channel; and
detecting an emergency when the base station misses a predetermined number of expected cycles of the cyclic radio signal.

(37) The method of (36), wherein the cyclic radio signal indicates a normal operation mode.

(38) The method of (36) or (37), further comprising:
sending, via semi-persistent scheduling, an emergency indication.

(39) The method of anyone of (36) to (38), wherein the network is configured to provide time-sensitive communication.

(40) The method of anyone of (36) to (39), further comprising:
receiving additional information from the user equipment when an emergency function is activated on the user equipment.

(41) The method of (40), wherein the additional information includes at least one of an indication of an occurrence and a timestamp.

(42) The method of (40) or (41), wherein the additional information is received on a different channel than the permanent channel.

(43) The method of anyone of (36) to (42), further comprising:
establishing a configured grant for a plurality of user equipments.

(44) The method of (43), further comprising:
allocating dedicated resources for each of the plurality of user equipments.

(45) The method of anyone of (36) to (44), further comprising:
re-allocating a predetermined amount of resources for handling the emergency.

(46) The method of anyone of (36) to (45), wherein the mobile telecommunications network is a 5G network.

(47) The method of anyone of (36) to (46), wherein the mobile telecommunications network is an industrial internet of things network.

(48) The method of anyone of (36) to (47), wherein the mobile telecommunications network is a 5G industrial internet of things network.

(49) A user equipment for a mobile telecommunications network, the user equipment comprising circuitry configured to:
obtain surveillance data;
input the surveillance data into a machine vision algorithm;
determine a level of risk attributed to the surveillance data based on the machine vision algorithm; and
send, on a permanent channel which is established between the user equipment and a communication network node, an emergency command, if the level of risk exceeds a predetermined threshold.

(50) The user equipment of (49), wherein the circuitry is further configured to:
send the emergency command on a predefined quality of service flow.

(51) The user equipment of (50), wherein the predefined quality of service flow is defined as safety communication.

(52) The user equipment of (50) or (51), wherein the circuitry is further configured to:
prioritize the emergency command over data which are to be sent on a different quality of service flow.

(53) The user equipment of anyone of (50) to (52), wherein the circuitry is further configured to:
send, via the communication network node, a data stream on a different quality of service flow when it is determined that the level of risk is below the predetermined threshold.

(54) The user equipment of (53), wherein the data stream is sent on a different channel than the permanent channel.

(55) The user equipment of anyone of (50) to (54), wherein the quality of service flow is based on a quality of service definition.

(56) The user equipment of (55), wherein the quality of service definition is based on at least one of an application of the user equipment, a safety requirement, a communication type, a latency, a packet error rate, and a redundancy path requirement.

(57) The user equipment of (55) or (56), wherein the quality of service definition is based on RAN assistance information.

(58) The user equipment of (57), wherein the RAN assistance information is used to override an existing quality of service definition.

(59) The user equipment of (58), wherein the circuitry is further configured to:
override the existing quality of service definition based on an application requirement of the user equipment.

(60) The user equipment of anyone of (49) to (59), wherein the permanent channel is a cyclic channel.

(61) The user equipment of (60), wherein the cyclic channel is an ultra reliable low latency communication, URLLC, channel.

(62) The user equipment of anyone of (49) to (61), wherein the emergency command indicates a machine to slow down its operation speed or to stop its operation.

(63) The user equipment of (62), wherein the emergency command indicates the machine to slow down its operation when it is recognized that a distance between a human and the machine is within a predetermined range.

(64) The user equipment of (63), wherein the emergency command indicates the machine to stop its operation when it is recognized that a distance between the human and the machine is below the predetermined range.

(65) The user equipment of anyone of (49) to (64), wherein the mobile telecommunications network is a 5G network.

(66) The user equipment of anyone of (49) to (65), wherein the mobile telecommunications network is an industrial internet of things network.

(67) The user equipment of anyone of (49) to (66), wherein the mobile telecommunications network is a 5G industrial internet of things network.

(68) The user equipment of anyone of (49) to (67), wherein the communication network node is a server.

(69) The user equipment of (68), wherein the server is a cloud server.

(70) The user equipment of (68) or (69), wherein the server is a factory server.

(71) A communication network node for a mobile telecommunications network, the user equipment comprising circuitry configured to:
receive, via a permanent channel which is established between the communication network node and a user equipment, an emergency command from the user equipment;
forward, on a permanent channel which is established between the communication network node and a user equipment, the emergency command.

(72) The communication network node of (71), wherein the circuitry is further configured to:
receive the emergency command on a predefined quality of service flow.

(73) The communication network node of (72), wherein the predefined quality of service flow is defined as safety communication.

(74) The communication network node of (72) or (73), wherein the circuitry is further configured to:
prioritize the emergency command over data which are to be sent on a different quality of service flow.

(75) The communication network node of anyone of (72) to (74), wherein the quality of service flow is based on a quality of service definition.

(76) The communication network node of (75), wherein the quality of service definition is based on at least one of an application of the user equipment, a safety requirement, a communication type, a latency, a packet error rate, and a redundancy path requirement.

(77) The communication network node of (75) or (76), wherein the quality of service definition is based on RAN assistance information.

(78) The communication network node of (77), wherein the RAN assistance information is used to override an existing quality of service definition.

(79) The communication network node of (78), wherein the circuitry is further configured to:
override the existing quality of service definition based on an application requirement of the user equipment.

(80) The communication network node of anyone of (71) to (79), wherein the permanent channel is a cyclic channel.

(81) The communication network node of (80), wherein the cyclic channel is an ultra reliable low latency communication, URLLC, channel.

(82) The communication network node of anyone of (71) to (81), wherein the emergency command indicates a machine to slow down its operation speed or to stop its operation.

(83) The communication network node of (82), wherein the emergency command indicates the machine to slow down its operation when it is recognized that a distance between a human and the machine is within a predetermined range.

(84) The communication network node of (83), wherein the emergency command indicates the machine to stop its operation when it is recognized that a distance between the human and the machine is below the predetermined range.

(85) The communication network node of anyone of (71) to (84), wherein the mobile telecommunications network is a 5G network.

(86) The communication network node of anyone of (71) to (85), wherein the mobile telecommunications network is an industrial internet of things network.

(87) The communication network node of anyone of (71) to (86), wherein the mobile telecommunications network is a 5G industrial internet of things network.

(88) The communication network node of anyone of (71) to (87), wherein the communication network node is a server.

(89) The communication network node of (88), wherein the server is a cloud server.

(90) The communication network node of (88) or (89), wherein the server is a factory server.

(91) A method carried out in a user equipment for a mobile telecommunications network, the method comprising:
obtaining surveillance data;
inputting the surveillance data into a machine vision algorithm;
determining a level of risk attributed to the surveillance data based on the machine vision algorithm; and
sending, on a permanent channel which is established between the user equipment and a communication network node, an emergency command, if the level of risk exceeds a predetermined threshold.

(92) The method of (91), further comprising:
sending the emergency command on a predefined quality of service flow.

(93) The method of (91), wherein the predefined quality of service flow is defined as safety communication.

(94) The method of (92) or (93), further comprising:
prioritizing the emergency command over data which are to be sent on a different quality of service flow.

(95) The method of anyone of (92) to (94), further comprising:
sending, via the communication network node, a data stream on a different quality of service flow when it is determined that the level of risk is below the predetermined threshold.

(96) The method of (95), wherein the data stream is sent on a different channel than the permanent channel.

(97) The method of anyone of (92) to (96), wherein the quality of service flow is based on a quality of service definition.

(98) The method of (97), wherein the quality of service definition is based on at least one of an application of the user equipment, a safety requirement, a communication type, a latency, a packet error rate, and a redundancy path requirement.

(99) The method of (97) or (98), wherein the quality of service definition is based on RAN assistance information.

(100) The method of (99), wherein the RAN assistance information is used to override an existing quality of service definition.

(101) The method of (100), further comprising:
overriding the existing quality of service definition based on an application requirement of the user equipment.

(102) The method of anyone of (91) to (101), wherein the permanent channel is a cyclic channel.

(103) The method of (102), wherein the cyclic channel is an ultra reliable low latency communication, URLLC, channel.

(104) The method of anyone of (91) to (103), wherein the emergency command indicates a machine to slow down its operation speed or to stop its operation.

(105) The method of (104), wherein the emergency command indicates the machine to slow down its operation when it is recognized that a distance between a human and the machine is within a predetermined range.

(106) The method of (105), wherein the emergency command indicates the machine to stop its operation when it is recognized that a distance between the human and the machine is below the predetermined range.

(107) The method of anyone of (91) to (106), wherein the mobile telecommunications network is a 5G network.

(108) The method of anyone of (91) to (107), wherein the mobile telecommunications network is an industrial internet of things network.

(109) The method of anyone of (91) to (108), wherein the mobile telecommunications network is a 5G industrial internet of things network.

(110) The method of anyone of (91) to (109), wherein the communication network node is a server.

(111) The method of (110), wherein the server is a cloud server.

(112) The method of (110) or (111), wherein the server is a factory server.

(113) A method carried out in a communication network node for a mobile telecommunications network, the method comprising:
receiving, via a permanent channel which is established between the communication network node and a user equipment, an emergency command from the user equipment;
forwarding, on a permanent channel which is established between the communication network node and a user equipment, the emergency command.

(114) The method of (113), further comprising:
receiving the emergency command on a predefined quality of service flow.

(115) The user equipment of (114), wherein the predefined quality of service flow is defined as safety communication.

(116) The method of (114) or (115), further comprising:
prioritizing the emergency command over data which are to be sent on a different quality of service flow.

(117) The method of anyone of (114) to (116), wherein the quality of service flow is based on a quality of service definition.

(118) The method of (117), wherein the quality of service definition is based on at least one of an application of the user equipment, a safety requirement, a communication type, a latency, a packet error rate, and a redundancy path requirement.

(119) The method of (117) or (118), wherein the quality of service definition is based on RAN assistance information.

(120) The method of (119), wherein the RAN assistance information is used to override an existing quality of service definition.

(121) The method of (120), further comprising: overriding the existing quality of service definition based on an application requirement of the user equipment.

(122) The method of anyone of (113) to (121), wherein the permanent channel is a cyclic channel.

(123) The method of (122), wherein the cyclic channel is an ultra reliable low latency communication, URLLC, channel.

(124) The method of anyone of (113) to (123), wherein the emergency command indicates a machine to slow down its operation speed or to stop its operation.

(125) The method of (124), wherein the emergency command indicates the machine to slow down its operation when it is recognized that a distance between a human and the machine is within a predetermined range.

(126) The method of (125), wherein the emergency command indicates the machine to stop its operation when it is recognized that a distance between the human and the machine is below the predetermined range.

(127) The method of anyone of (113) to (126), wherein the mobile telecommunications network is a 5G network.

(128) The method of anyone of (113) to (127), wherein the mobile telecommunications network is an industrial internet of things network.

(129) The method of anyone of (113) to (128), wherein the mobile telecommunications network is a 5G industrial internet of things network.

(130) The method of anyone of (113) to (129), wherein the communication network node is a server.

(131) The method of anyone of (113) to (130), wherein the server is a cloud server.

(132) The method of (130) or (131), wherein the server is a factory server.

(133) A computer program comprising program code causing a computer to perform the method according to anyone of (25) to (35), (36) to (48), (91) to (112), and/or (113) to (132) when being carried out on a computer.

(134) A non-transitory computer-readable recording medium that stores therein a computer program product, which, when executed by a processor, causes the method according to anyone of (25) to (35), (36) to (48), (91) to (112), and/or (113) to (132) to be performed.

Please also note that the present technology can be configured as described below:

(1) A user equipment for a mobile telecommunications network, the user equipment comprising circuitry configured to:
transmit, to a base station, a signal of operation status indication, wherein the signal of operation status indication is transmitted within a predetermined time interval from a previous transmission of an operation status indication.

(2) The user equipment of (1), wherein the signal indicates normal operation status if a time between the transmission of the signal and the previous transmission is within the predetermined time interval.

(3) The user equipment of (1) or (2), wherein the signal indicates an emergency status if a time between the transmission of the signal and the previous transmission is longer than the predetermined time interval.

(4) The user equipment of anyone of (1) to (3), wherein the signal of operation status indication is transmitted based on allocated resources configured by the base station.

(5) The user equipment of (4), wherein the resources are allocated with a configured grant.

(6) The user equipment of (4), wherein the resources are allocated with a cyclic transmission.

(7) The user equipment of anyone of (1) to (6), wherein the signal indicates a normal operation mode.

(8) The user equipment of anyone of (1) to (7), wherein the signal indicates an emergency status.

(9) The user equipment of anyone of (1) to (8), wherein the circuitry is further configured to:
end transmission of the signal when an emergency function is activated.

(10) The user equipment of anyone of (1) to (9), wherein the network is configured to provide time-sensitive communication with the user equipment.

(11) The user equipment of anyone of (1) to (10), wherein the circuitry is further configured to:
send additional information when an emergency function is activated.

(12) The user equipment of (11), wherein the additional information includes at least one of an indication of an occurrence and a timestamp.

(13) The user equipment of anyone of (1) to (12), wherein the signal is transmitted based on at least one of power boosting and signal repetition.

(14) The user equipment of anyone of (1) to (13), wherein the mobile telecommunications network is a 5G network.

(15) The user equipment of anyone of (1) to (14), wherein the mobile telecommunications network is an industrial internet of things network.

(16) The user equipment of anyone of (1) to (15), wherein the mobile telecommunications network is a 5G industrial internet of things network.

(17) A user equipment for a mobile telecommunications network, the user equipment comprising circuitry configured to:
receive, from a base station, with allocated resources an emergency indication; and
carry out an emergency action in response to receiving the emergency indication.

(18) The user equipment of (17), wherein the resources are allocated by dynamic grant scheduling.

(19) The user equipment of (17) or (18), wherein the resources are allocated by semi-persistent scheduling.

(20) The user equipment of anyone of (17) to (19), wherein the circuitry is further configured to:
receive a signal with semi-persistent scheduling indicating a normal operation mode.

(21) The user equipment of anyone of (17) to (20), wherein the network is configured to provide time-sensitive communication with the user equipment.

(22) The user equipment of anyone of (17) to (21), wherein the circuitry is further configured to:
send additional information when the emergency indication is received.

(23) The user equipment of (22), wherein the additional information includes at least one of an indication of an occurrence and a timestamp.

(24) The user equipment of anyone of (17) to (23), wherein the signal is transmitted based on at least one of power boosting and signal repetition.

(25) The user equipment of anyone of (17) to (24), wherein the mobile telecommunications network is a 5G network.

(26) The user equipment of anyone of (17) to (25), wherein the mobile telecommunications network is an industrial internet of things network.

(27) The user equipment of anyone of (17) to (26), wherein the mobile telecommunications network is a 5G industrial internet of things network.

(28) A base station for a mobile telecommunications network, the base station comprising circuitry configured to:
receive, from the user equipment, a signal of operation status indication, wherein the signal of operation status indication is transmitted within a predetermined time interval from a previous transmission of an operation status indication.

(29) The base station of (28), wherein signal indicates normal operation status if a time between the transmission of the signal and the previous transmission is within a predetermined time interval.

(30) The base station of (28) or (29), wherein the signal indicates an emergency status if a time between the transmission of the signal and the previous transmission is longer than the predetermined time interval.

(31) The base station of anyone of (28) to (30), wherein the signal of operation status indication is transmitted based on allocated resources configured by the base station.

(32) The base station of (31), wherein the resources are allocated with a configured grant.

(33) The base station of (31) or (32), wherein the resources are allocated with a cyclic transmission.

(34) The base station of anyone of (28) to (33), wherein the signal indicates a normal operation mode.

(35) The base station of anyone of (28) to (34), wherein the signal indicates an emergency status.

(36) The base station of anyone of (28) to (35), wherein the circuitry is further configured to:
detect an emergency when a time between the reception of the signal and the previous reception is longer than the predetermined time interval.

(37) The base station of (36), wherein the circuitry is further configured to:
receive additional information when the emergency is detected.

(38) The base station of anyone of (28) to (37), wherein the circuitry is further configured to:
receive additional information from the user equipment when an emergency function is activated on the user equipment.

(39) The base station of (38), wherein the additional information includes at least one of an indication of an occurrence and a timestamp.

(40) The base station of anyone of (28) to (39), wherein the circuitry is further configured to:
re-allocate a predetermined amount of resources for handling the emergency.

(41) The base station of anyone of (28) to (40), wherein the mobile telecommunications network is a 5G network.

(42) The base station of anyone of (28) to (41), wherein the mobile telecommunications network is an industrial internet of things network.

(43) The base station of anyone of (28) to (42), wherein the mobile telecommunications network is a 5G industrial internet of things network configured to provide a time-sensitive communication with the user equipment.

(44) A base station for a mobile telecommunications network, the base station comprising circuitry configured to:
send, to a user equipment, with allocated resources an emergency indication.

(45) The base station of (44), wherein the resources are allocated by dynamic grant scheduling.

(46) The base station of (44) or (45), wherein the resources are allocated by semi-persistent scheduling.

(47) The base station of anyone of (44) to (46), wherein the circuitry is further configured to:
send a signal with semi-persistent scheduling indicating a normal operation mode.

(48) The base station of anyone of (44) to (47), wherein the network is configured to provide time-sensitive communication with the user equipment.

(49) The base station of anyone of (44) to (48), wherein the circuitry is further configured to:
receive additional information when the emergency indication is received.

(50) The base station of (49), wherein the additional information includes at least one of an indication of an occurrence and a time stamp.

(51) The base station of anyone of (44) to (50), wherein the signal is transmitted based on at least one of power boosting and signal repetition.

(52) The base station of anyone of (44) to (51), wherein the mobile telecommunications network is a 5G network.

(53) The base station of anyone of (44) to (52), wherein the mobile telecommunications network is an industrial internet of things network.

(54) The base station of anyone of (44) to (53), wherein the mobile telecommunications network is a 5G industrial internet of things network.

(55) A method carried out in a user equipment for a mobile telecommunications network, the method comprising:
transmitting, to a base station, a signal of operation status indication, wherein the signal of operation status indication is transmitted within a predetermined time interval from a previous transmission of an operation status indication.

(56) The method of (55), wherein the signal indicates normal operation if a time between the transmission of the signal and the previous transmission is within the predetermined time interval.

(57) The method of (55) or (56), wherein the signal indicates an emergency status if a time between the transmission of the signal and the previous transmission is longer than the predetermined time interval.

(58) The method of anyone of (55) to (57), wherein the signal of operation status indication is transmitted based on allocated resources configured by the base station.

(59) The method of (58), wherein the resources are allocated with a configured grant.

(60) The method of (58) or (59), wherein the resources are allocated with a cyclic transmission.

(61) The method of anyone of (55) to (60), wherein the signal indicates a normal operation mode.

(62) The method of anyone of (55) to (61), wherein the signal indicates an emergency status.

(63) The method of anyone of (55) to (62), further comprising ending transmission of the signal when an emergency function is activated.

(64) The method of anyone of (55) to (63), wherein the network is configured to provide time-sensitive communication with the user equipment.

(65) The method of anyone of (55) to (64), further comprising:
sending additional information when an emergency function is activated.

(66) The method of (65), wherein the additional information includes at least one of an indication of an occurrence and a timestamp.

(67) The method of anyone of (55) to (66), wherein the signal is transmitted based on at least one of power boosting and signal repetition.

(68) The method of anyone of (55) to (67), wherein the mobile telecommunications network is a 5G network.

(69) The method of anyone of (55) to (68), wherein the mobile telecommunications network is an industrial internet of things network.

(70) The method of anyone of (55) to (68), wherein the mobile telecommunications network is a 5G industrial internet of things network.

(71) A method carried out in a user equipment for a mobile telecommunications network, the method comprising:
receiving, from a base station, with allocated resources an emergency indication; and
carrying out an emergency action in response to receiving the emergency indication.

(72) The method of (71), wherein the resources are allocated by dynamic grant scheduling.

(73) The method of (71) or (72), wherein the resources are allocated by semi-persistent scheduling.

(74) The method of anyone of (71) to (73), further comprising:
receiving a signal with semi-persistent scheduling indicating a normal operation mode.

(75) The method of anyone of (71) to (74), wherein the network is configured to provide time-sensitive communication with the user equipment.

(76) The method of anyone of (71) to (75), further comprising:
sending additional information when the emergency indication is received.

(77) The method of (76), wherein the additional information includes at least one of an indication of an occurrence and a timestamp.

(78) The method of anyone of (71) to (77), wherein the signal is transmitted based on at least one of power boosting and signal repetition.

(79) The method of anyone of (71) to (78), wherein the mobile telecommunications network is a 5G network.

(80) The method of anyone of (71) to (79), wherein the mobile telecommunications network is an industrial internet of things network.

(81) The method of anyone of (71) to (80), wherein the mobile telecommunications network is a 5G industrial internet of things network.

(82) A method carried out in a base station for a mobile telecommunications network, the method comprising:
receiving, from a user equipment, a signal of operation status indication, wherein the signal of operation status indication is transmitted within a predetermined time interval from a previous transmission of an operation status indication.

(83) The method of (82), wherein signal indicates normal operation status if a time between the transmission of the signal and the previous transmission is within a predetermined time interval.

(84) The method of (82) or (83), wherein the signal indicates an emergency status if a time between the transmission of the signal and the previous transmission is longer than the predetermined time interval.

(85) The method of anyone of (82) to (84), wherein the signal of operation status indication is transmitted based on allocated resources configured by the base station.

(86) The method of (85), wherein the resources are allocated with a configured grant.

(87) The method of (85) or (86), wherein the resources are allocated with a cyclic transmission.

(88) The method of anyone of (82) to (87), wherein the signal indicates a normal operation mode.

(89) The method of anyone of (82) to (88), wherein the signal indicates an emergency status.

(90) The method of anyone of (82) to (89), further comprising:
detecting an emergency when a time between the reception of the signal and the previous reception is longer than the predetermined time interval.

(91) The method of (90), further comprising:
receiving additional information when the emergency is detected.

(92) The method of anyone of (82) to (91), wherein the network is configured to provide time-sensitive communication.

(93) The method of anyone of (82) to (92), wherein the circuitry is further configured to:
receive additional information from the user equipment when an emergency function is activated on the user equipment.

(94) The method of (93), wherein the additional information includes at least one of an indication of an occurrence and a timestamp.

(95) The method of anyone of (82) to (94), further comprising:
re-allocating a predetermined amount of resources for handling the emergency.

(96) The method of anyone of (82) to (95), wherein the mobile telecommunications network is a 5G network.

(97) The method of anyone of (82) to (96), wherein the mobile telecommunications network is an industrial internet of things network.

(98) The method of anyone of (82) to (97), wherein the mobile telecommunications network is a 5G industrial internet of things network.

(99) A method carried out in a base station for a mobile telecommunications network, the method comprising:
sending, to a user equipment, with allocated resources an emergency indication.

(100) The method of (99), wherein the resources are allocated by dynamic grant scheduling.

(101) The method of (99) or (100), wherein the resources are allocated by semi-persistent scheduling.

(102) The method of anyone of (99) to (101), further comprising:
send a signal with semi-persistent scheduling indicating a normal operation mode.

(103) The method of anyone of (99) to (102), wherein the network is configured to provide time-sensitive communication with the user equipment.

(104) The method of anyone of (99) to (103), further comprising:
receiving additional information when the emergency indication is received.

(105) The method of (104), wherein the additional information includes at least one of an indication of an occurrence and a time stamp.

(106) The method of anyone of (99) to (105), wherein the signal is transmitted based on at least one of power boosting and signal repetition.

(107) The method of anyone of (99) to (106), wherein the mobile telecommunications network is a 5G network.

(108) The method of anyone of (99) to (107), wherein the mobile telecommunications network is an industrial internet of things network.

(109) The method of anyone of (99) to (108), wherein the mobile telecommunications network is a 5G industrial internet of things network.

(110) A user equipment for a mobile telecommunications network, the user equipment comprising circuitry configured to:
obtain surveillance data;
input the surveillance data into a machine vision algorithm;
determine a level of risk attributed to the surveillance data based on the machine vision algorithm; and
send an emergency command, if the level of risk exceeds a predetermined threshold.

(111) The user equipment of (110), wherein the circuitry is further configured to:
send the emergency command on a predefined quality of service flow.

(112) The user equipment of (111), wherein the predefined quality of service flow is defined as safety communication.

(113) The user equipment of (111) or (112), wherein the circuitry is further configured to:
prioritize the emergency command over data which are to be sent on a different quality of service flow.

(114) The user equipment of anyone of (111) to (113), wherein the circuitry is further configured to:
send, via the communication network node, a data stream on a different quality of service flow when it is determined that the level of risk is below the predetermined threshold.

(115) The user equipment of (114), wherein the data stream is sent on a different channel than the permanent channel.

(116) The user equipment of anyone of (111) to (115), wherein the quality of service flow is based on a quality of service definition.

(117) The user equipment of (116), wherein the quality of service definition is based on at least one of an application of the user equipment, a safety requirement, a communication type, a latency, a packet error rate, and a redundancy path requirement.

(118) The user equipment of (116) or (117), wherein the quality of service definition is based on RAN assistance information.

(119) The user equipment of (118), wherein the RAN assistance information is used to override an existing quality of service definition.

(120) The user equipment of (119), wherein the circuitry is further configured to:
override the existing quality of service definition based on an application requirement of the user equipment.

(121) The user equipment of anyone of (110) to (120), wherein the permanent channel is a cyclic channel.

(122) The user equipment of (121), wherein the cyclic channel is an ultra reliable low latency communication, URLLC, channel.

(123) The user equipment of anyone of (110) to (122), wherein the emergency command indicates a machine to slow down its operation speed or to stop its operation.

(124) The user equipment of (123), wherein the emergency command indicates the machine to slow down its operation when it is recognized that a distance between a human and the machine is within a predetermined range.

(125) The user equipment of (124), wherein the emergency command indicates the machine to stop its operation when it is recognized that a distance between the human and the machine is below the predetermined range.

(126) The user equipment of anyone of (110) to (125), wherein the mobile telecommunications network is a 5G network.

(127) The user equipment of anyone of (110) to (126), wherein the mobile telecommunications network is an industrial internet of things network.

(128) The user equipment of anyone of (110) to (127), wherein the mobile telecommunications network is a 5G industrial internet of things network.

(129) The user equipment of anyone of (110) to (128), wherein the communication network node is a server.

(130) The user equipment of (129), wherein the server is a cloud server.

(131) The user equipment of (129) or (130), wherein the server is a factory server.

(132) A communication network node for a mobile telecommunications network, the user equipment comprising circuitry configured to:
receive an emergency command from the user equipment.

(133) The communication network node of (132), wherein the circuitry is further configured to:
receive the emergency command on a predefined quality of service flow.

(134) The communication network node of (133), wherein the predefined quality of service flow is defined as safety communication.

(135) The communication network node of (134), wherein the circuitry is further configured to:
prioritize the emergency command over data which are to be sent on a different quality of service flow.

(136) The communication network node of (134) or (135), wherein the quality of service flow is based on a quality of service definition.

(137) The communication network node of (136), wherein the quality of service definition is based on at least one of an application of the user equipment, a safety requirement, a communication type, a latency, a packet error rate, and a redundancy path requirement.

(138) The communication network node of (136) or (137), wherein the quality of service definition is based on RAN assistance information.

(139) The communication network node of (138), wherein the RAN assistance information is used to override an existing quality of service definition.

(140) The communication network node of (139), wherein the circuitry is further configured to:
override the existing quality of service definition based on an application requirement of the user equipment.

(141) The communication network node of anyone of (132) to (140), wherein the permanent channel is a cyclic channel.

(142) The communication network node of (141), wherein the cyclic channel is an ultra reliable low latency communication, URLLC, channel.

(143) The communication network node of anyone of (132) to (142), wherein the emergency command indicates a machine to slow down its operation speed or to stop its operation.

(144) The communication network node of (143), wherein the emergency command indicates the machine to slow down its operation when it is recognized that a distance between a human and the machine is within a predetermined range.

(145) The communication network node of (144), wherein the emergency command indicates the machine to stop its operation when it is recognized that a distance between the human and the machine is below the predetermined range.

(146) The communication network node of anyone of (132) to (145), wherein the mobile telecommunications network is a 5G network.

(147) The communication network node of anyone of (132) to (146), wherein the mobile telecommunications network is an industrial internet of things network.

(148) The communication network node of anyone of (132) to (147), wherein the mobile telecommunications network is a 5G industrial internet of things network.

(149) The communication network node of anyone of (132) to (147), wherein the communication network node is a server.

(150) The communication network node of (149), wherein the server is a cloud server.

(151) The communication network node of (149) or (150), wherein the server is a factory server.

(152) A method carried out in a user equipment for a mobile telecommunications network, the method comprising:
obtaining surveillance data;
inputting the surveillance data into a machine vision algorithm;
determining a level of risk attributed to the surveillance data based on the machine vision algorithm; and
sending an emergency command, if the level of risk exceeds a predetermined threshold.

(153) The method of (152), further comprising:
sending the emergency command on a predefined quality of service flow.

(154) The method of (153), wherein the predefined quality of service flow is defined as safety communication.

(155) The method of (153) or (154), further comprising: :
prioritizing the emergency command over data which are to be sent on a different quality of service flow.

(156) The method of anyone of (153) to (155), further comprising: :
sending, via the communication network node, a data stream on a different quality of service flow when it is determined that the level of risk is below the predetermined threshold.

(157) The method of (156), wherein the data stream is sent on a different channel than the permanent channel.

(158) The method of anyone of (153) to (157), wherein the quality of service flow is based on a quality of service definition.

(159) The method of (158), wherein the quality of service definition is based on at least one of an application of the user equipment, a safety requirement, a communication type, a latency, a packet error rate, and a redundancy path requirement.

(160) The method of (158) or (159), wherein the quality of service definition is based on RAN assistance information.

(161) The method of (160), wherein the RAN assistance information is used to override an existing quality of service definition.

(162) The method of (161), further comprising: :
overriding the existing quality of service definition based on an application requirement of the user equipment.

(163) The method of (162), wherein the permanent channel is a cyclic channel.

(164) The method of (163), wherein the cyclic channel is an ultra reliable low latency communication, URLLC, channel.

(165) The method of anyone of (162) to (164), wherein the emergency command indicates a machine to slow down its operation speed or to stop its operation.

(166) The method of (165), wherein the emergency command indicates the machine to slow down its operation when it is recognized that a distance between a human and the machine is within a predetermined range.

(167) The method of (166), wherein the emergency command indicates the machine to stop its operation when it is recognized that a distance between the human and the machine is below the predetermined range.

(168) The method of anyone of (162) to (167), wherein the mobile telecommunications network is a 5G network.

(169) The method of anyone of (162) to (168), wherein the mobile telecommunications network is an industrial internet of things network.

(170) The method of anyone of (162) to (169), wherein the mobile telecommunications network is a 5G industrial internet of things network.

(171) The method of anyone of (162) to (170), wherein the communication network node is a server.

(172) The method of (171), wherein the server is a cloud server.

(173) The method of (171) or (172), wherein the server is a factory server.

(174) A method carried out in a communication network node for a mobile telecommunications network, the method comprising:
receiving an emergency command from the user equipment.

(175) The method of (174), further comprising:
receiving the emergency command on a predefined quality of service flow.

(176) The user equipment of (175), wherein the predefined quality of service flow is defined as safety communication.

(177) The method of (175) or (176), further comprising:
prioritizing the emergency command over data which are to be sent on a different quality of service flow.

(178) The method of anyone of (175) to (177), wherein the quality of service flow is based on a quality of service definition.

(179) The method of (178), wherein the quality of service definition is based on at least one of an application of the user equipment, a safety requirement, a communication type, a latency, a packet error rate, and a redundancy path requirement.

(180) The method of (178) or (179), wherein the quality of service definition is based on RAN assistance information.

(181) The method of (180), wherein the RAN assistance information is used to override an existing quality of service definition.

(182) The method of (181), further comprising:
overriding the existing quality of service definition based on an application requirement of the user equipment.

(183) The method of anyone of (174) to (182), wherein the emergency command indicates a machine to slow down its operation speed or to stop its operation.

(184) The method of (183), wherein the emergency command indicates the machine to slow down its operation when it is recognized that a distance between a human and the machine is within a predetermined range.

(185) The method of (184), wherein the emergency command indicates the machine to stop its operation when it is recognized that a distance between the human and the machine is below the range.

(186) The method of anyone of (174) to (185), wherein the mobile telecommunications network is a 5G network.

(187) The method of anyone of (174) to (186), wherein the mobile telecommunications network is an industrial internet of things network.

(188) The method of anyone of (174) to (187), wherein the mobile telecommunications network is a 5G industrial internet of things network.

(189) The method of anyone of (174) to (188), wherein the communication network node is a server.

(190) The method of (189), wherein the server is a cloud server.

(191) The method of (189) or (190), wherein the server is a factory server.

### REFERENCES

[1] https://www. cisco.com/c/dam/en/us/solutions/collateral/industry-solutions/white-paper-c11-738950.pdf
[2] https://5g-acia.org/wp-content/uploads/2021/04/5G-ACIA_Integration-of-Industrial-Ethernet-Networks-with-5G-Networks-.pdf

1. A user equipment for a mobile telecommunications network, the user equipment comprising circuitry configured to:
transmit, to a base station, a signal of operation status indication, wherein the signal of operation status indication is transmitted within a predetermined time interval from a previous transmission of an operation status indication.

2. The user equipment of claim 1, wherein the signal indicates normal operation status if a time between the transmission of the signal and the previous transmission is within the predetermined time interval.

3. The user equipment of claim 1, wherein the signal indicates an emergency status if a time between the transmission of the signal and the previous transmission is longer than the predetermined time interval.

4. The user equipment of claim 1, wherein the signal of operation status indication is transmitted based on allocated resources configured by the base station.

5.-6. (canceled)

7. The user equipment of claim 1, wherein the signal indicates a normal operation mode.

8. The user equipment of claim 1, wherein the signal indicates an emergency status.

9. The user equipment of claim 1, wherein the circuitry is further configured to:
end transmission of the signal when an emergency function is activated.

10. The user equipment of claim 1, wherein the network is configured to provide time-sensitive communication with the user equipment.

11. The user equipment of claim 1, wherein the circuitry is further configured to:
send additional information when an emergency function is activated.

12. The user equipment of claim 11, wherein the additional information includes at least one of an indication of an occurrence and a timestamp.

13.-27. (canceled)

28. A base station for a mobile telecommunications network, the base station comprising circuitry configured to:
receive, from the user equipment, a signal of operation status indication, wherein the signal of operation status indication is transmitted within a predetermined time interval from a previous transmission of an operation status indication.

29. The base station of claim 28, wherein signal indicates normal operation status if a time between the transmission of the signal and the previous transmission is within a predetermined time interval.

30. The base station of claim 28, wherein the signal indicates an emergency status if a time between the transmission of the signal and the previous transmission is longer than the predetermined time interval.

31. The base station of claim 28, wherein the signal of operation status indication is transmitted based on allocated resources configured by the base station.

32.-43. (canceled)

44. A base station for a mobile telecommunications network, the base station comprising circuitry configured to:
send, to a user equipment, with allocated resources an emergency indication.

45. The base station of claim 44, wherein the resources are allocated by dynamic grant scheduling.

46. The base station of claim wherein the resources are allocated by semi-persistent scheduling.

47. The base station of claim 44, wherein the circuitry is further configured to:
send a signal with semi-persistent scheduling indicating a normal operation mode.

48. The base station of claim 44, wherein the network is configured to provide time-sensitive communication with the user equipment.

49. The base station of claim 44, wherein the circuitry is further configured to:
receive additional information when the emergency indication is received.

50.-191. (canceled)
